(19) United States
(12) Patent Application Publication
(10) Pub. No.: US 2026/0170692 A1
(43) Pub. Date: Jun. 18, 2026

(54) METHOD, APPARATUS AND COMPUTER- READABLE STORAGE MEDIUM FOR DETERMINING ROI OF A SCENE

(71) Applicant: Harman International Industries, Incorporated, Stamford, CT (US)

(72) Inventors: Rengao Zhou, Shanghai (CN); Hanyu Shang, Shanghai (CN); Yuanbo ZHENG, Shanghai (CN)

(21) Appl. No.: 19/126,621

(22) PCT Filed: Dec. 2, 2022
(86) PCT No.: PCT/CN2022/136230

§ 371 Date: May 1, 2025

(51) Int. Cl. G06T 7/90; G06V 20/52

(52) U.S. Cl. CPC G06T 7/90; G06V 20/52

(57) ABSTRACT

A method, apparatus and computer-readable storage medium for determining a region of interest (ROI) of a scene are provided. The method comprises steps of:
a) determining a first region based on a first image of the scene;
b) acquiring a second image of the scene;
c) calculating a heat map of the second image and determining a target region in the heat map;
d) repeating steps b)-c) at a first frequency and shrinking the first region in response to the target regions of M consecutive second images being all inside the first region and differences between the target regions of the M consecutive second images and the first region being all greater than a first threshold; and e) determining the first region as the ROI of the scene in response to differences between the target regions of N consecutive second images and the first region being all equal to or smaller than the first threshold.

### TECHNICAL FIELD

The present disclosure relates to image processing with artificial intelligence. In particular, it relates to a method, apparatus and computer-readable storage medium for determining a region of interest (ROI) of a scene.

### BACKGROUND

In the field of artificial intelligence, it is valuable to determine a region of interest (ROI) in images of a scene, which can help to focus computing resources on the ROI. There is a method of selecting a fixed and pre-defined ROI of images of a scene. However, a predefined ROI could be not reliable, which may make negative impacts on the detection and classification results. A more reliable approach to determine a ROI of a scene is demanded.

For example, the Driver Monitoring System (DMS) is a popular and welcomed function in the Advanced Driving Assistance System (ADAS), which can monitor the status of the driver while driving, and can warn the driver and even apply braking if necessary. In the DMS, a lot of deep learning functions could be involved, for example, FaceID, Manual Distraction, Age Estimation, and HoSW (Hands off Steering Wheel). ROI determination could facilitate realization of those functions.

However, a predefined ROI is not always reliable. For example, when the drivers are different, when the orientation of camera changes, or when replacing the current camera with a different one of different resolution or Field of View (FOV), the fixed and predefined ROI would result in wrong classification or estimation results, and thus may even cause serious accidents.

### SUMMARY

In order to solve at least one of the above problems, embodiments of the present disclosure propose a method, apparatus and computer-readable storage medium for determining a region of interest (ROI) of a scene based on heat map calculation of the images of a scene, which can determine a reliable ROI for a scene.

In one representative aspect, there is provided a method for determining a region of interest (ROI) of a scene. This method comprises steps of: a) determining a first region based on a first image of the scene; b) acquiring a second image of the scene; c) calculating a heat map of the second image and determining a target region in the heat map; d) repeating steps b)-c) at a first frequency and shrinking the first region in response to the target regions of M consecutive second images being all inside the first region and differences between the target regions of the M consecutive second images and the first region being all greater than a first threshold, wherein Mis an integer larger than 1; and e) determining the first region as the ROI of the scene in response to differences between the target regions of N consecutive second images and the first region being all equal to or smaller than the first threshold, wherein Nis an integer equal to or larger than 1.

In another representative aspect, there is provided an apparatus for determining a region of interest (ROI) of a scene. The apparatus comprises a processor and a non-transitory memory with instructions thereon, wherein the instructions upon execution by the processor, cause the processor to execute the steps of: a) determining a first region based on a first image of the scene; b) acquiring a second image of the scene; c) calculating a heat map of the second image and determining a target region in the heat map; d) repeating steps b)-c) at a first frequency and shrinking the first region in response to the target regions of M consecutive second images being all inside the first region and differences between the target regions of the M consecutive second images and the first region being all greater than a first threshold, wherein M is an integer larger than 1; and e) determining the first region as the ROI of the scene in response to differences between the target regions of N consecutive second images and the first region being all equal to or smaller than the first threshold, wherein Nis an integer equal to or larger than 1.

In yet another representative aspect, there is provided a non-transitory computer-readable storage medium. The non-transitory computer-readable storage medium stores instructions that cause a processor to execute the steps of: a) determining a first region based on a first image of the scene; b) acquiring a second image of the scene; c) calculating a heat map of the second image and determining a target region in the heat map; d) repeating steps b)-c) at a first frequency and shrinking the first region in response to the target regions of M consecutive second images being all inside the first region and differences between the target regions of the M consecutive second images and the first region being all greater than a first threshold, wherein M is an integer larger than 1; and e) determining the first region as the ROI of the scene in response to differences between the target regions of N consecutive second images and the first region being all equal to or smaller than the first threshold, wherein Nis an integer equal to or larger than 1.

In some embodiments, shrinking the first region may comprise shrinking the first region by using a damping method with a shrinking step.

In some embodiments, the method may further comprise a step of f) monitoring the scene and updating the ROI if the scene changes.

In some embodiments, monitoring the scene may comprise steps of: g) acquiring a third image of the scene; h) calculating a heat map of the third image and determining the target region in the heat map; and i) repeating the foregoing steps g)-h) at a second frequency and determining that the scene changes in response to differences between the target regions of the K consecutive third images and the ROI being all greater than a second threshold, wherein K is an integer larger than 1.

In some embodiments, the second frequency can be lower than the first frequency.

In some embodiments, monitoring the scene may comprise steps of: acquiring sensing information of at least one object in the scene; and determining that the scene changes if the sensing information of at least one object changes.

In some embodiments, updating the ROI may comprise performing the foregoing steps a)-e) and replacing the ROI with a newly determined ROI.

In some embodiments, calculating a heat map of the second image and determining a target region in the heat map may comprise: extracting a heat value distribution of the second image by using a neural network; and determining the target region based on the heat value distribution of the second image.

In some embodiments, the heat map of the second image is a class activation map (CAM), and calculating a heat map of the second image comprising steps of: inputting the second image into the neural network; collecting each output map of each of a plurality of convolution layers of the neural network; and combining all of the output maps of the plurality of convolution layers into one map as the heat map of the second image.

This summary is provided to introduce a selection of concepts in a simplified form that are further described below in the description. This summary is not intended to identify key features or essential features of the claimed subject matter, nor is it intended to be used to limit the scope of the claimed subject matter.

These and other aspects are described in the present disclosure.

### BRIEF DESCRIPTION OF THE DRAWINGS

Various features of examples and embodiments in accordance with the principles described herein may be more readily understood with reference to the following detailed description taken in conjunction with the accompanying drawings, where like reference numerals designate like structural elements, and in which:

FIG. 1 illustrates an example flowchart of a method for determining a ROI of a scene according to one of a number of embodiments of the present disclosure;

FIG. 2 shows an example process of determining a first region of a scene according to one of a number of embodiments of the present disclosure;

FIG. 3 shows an example process of calculating a heat map and determining a target region according to one of a number of embodiments of the present disclosure;

FIG. 4 shows an example shrinking process to obtain the ROI according to one of a number of embodiments of the present disclosure;

FIG. 5 illustrates an example flowchart of a method for monitoring and updating the ROI of a scene according to one of a number of embodiments of the present disclosure;

FIG. 6 shows an example process for deciding whether to update the ROI of a scene according to one of a number of embodiments of the present disclosure;

FIG. 7 is a block diagram of an example apparatus for implementing the ROI determining method as described in the present disclosure;

FIG. 8 is an illustration of an example computer-readable storage medium for implementing the ROI determining method as described in the present disclosure.

These and other features are detailed below with reference to the above-referenced figures.

### DESCRIPTION OF THE EMBODIMENTS

The preferred embodiments of the present disclosure will now be described with reference to the drawings. Identical elements in the various figures are identified with the same reference numerals.

Reference will now be made in detail to each embodiment of the present disclosure. Such embodiments are provided by way of explanation of the present disclosure, which is not intended to be limited thereto. In fact, those of ordinary skill in the art may appreciate upon reading the present specification and viewing the present drawings that various modifications and variations may be made thereto.

Although some embodiments of the present disclosure are shown in the drawings, it should be understood that the present disclosure can be implemented in various forms, and should not be interpreted as limited to the embodiments described herein.

It also should be noted that the steps described in the method embodiments of the present disclosure can be executed in different order and/or in parallel, unless it is obviously unsuitable or explicitly stated to the contrary. Further, the method embodiments may include more steps and/or omit certain steps.

The term “comprising” and its variants used herein refers to “including but not limited to”. The term “based on” refers to “at least based on”. It should also be understood that the term “first”, “second” or “third” mentioned in the present disclosure are only used to distinguish different devices, modules or units, instead of to define the order or interdependence of functions performed by these devices, modules or units.

In order to simplify the description, various examples of determining the ROI of a scene according to a number of embodiments of the present disclosure are described below with the HoSW detection scenario in the DMS as an example, which is not a limitation, but an example.

In fact, the method described in the present disclosure can also be applied to many other application scenarios that may need determination of ROI, such as face authentication, focus monitoring, and so on. For example, considering the DMS, other DMS functions than the HoSW, such as FaceID, Manual Distraction, Age Estimation, may also use ROI and benefit from the embodiments of the present disclosure.

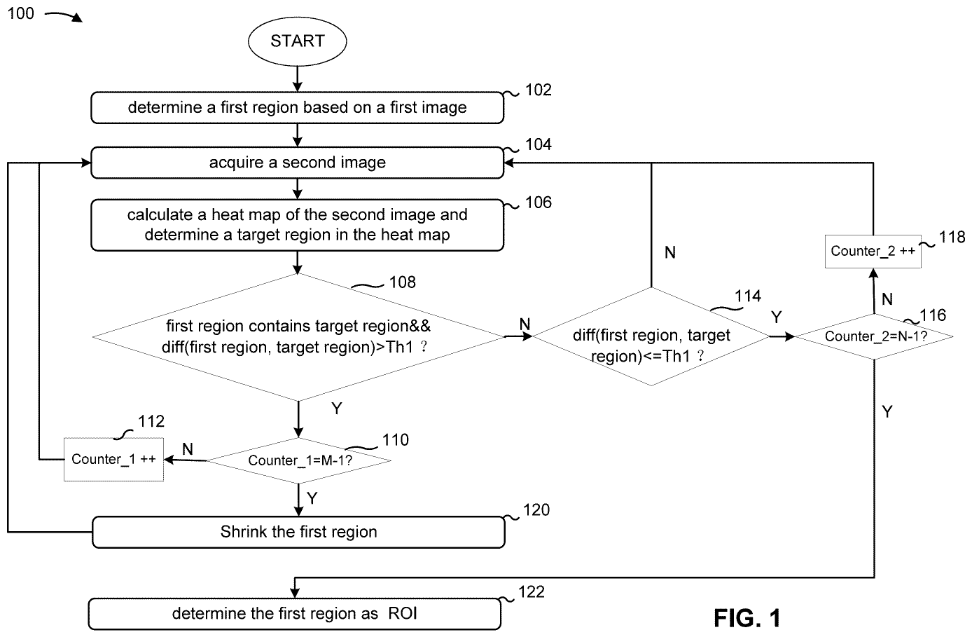

FIG. 1 illustrates an example flowchart of a method 100 for determining a ROI of a scene according to one of a number of embodiments of the present disclosure.

A scene in embodiments of the present disclosure may be any scene to be monitored, for example, a driver driving inside a car. The ROI of a scene may refer to any ROI of images taken for the scene, which may be used to realize a function such as detection or classification. For example, in the DMS, the ROI may be used to detect HoSW. In the scenario of HoSW detection, the ROI may include the part of steering wheel in an image taken for the scene of a driver driving inside a car.

As shown in FIG. 1, method 100 may comprise determining a first region based on a first image of the scene (step 102).

The first image may be an image captured by an image capture device or an image frame extracted from a video taken by a video capture device.

The “first region” refers to a region in an image of a scene which may be shrunk to obtain the ROI. The first region may also be referred to as an initial ROI.

The first region may be the entire region of an image (e.g. the first image) taken for the scene such that the ROI to be determined shall be covered by the first region.

Alternatively, the first region may be a region smaller than the entire region of the first image of the scene, but large enough to cover the ROI to be determined.

The first region can be determined simply based on the original version of the first image. For example, the first region can be determined as the entire region of the first image or a smaller predefined fixed region of the first image.

Alternatively, the first region can be determined based on the heat map corresponding to the first image.

In the field of deep learning, a heat map can be regarded as a visualized feature map of the output feature map. A heat map can reflect the position of the target object and it can help to easily understand which part of an image makes the neural network make the final classification decision.

For example, the heat map can provide a heat value distribution representing the possibilities that respective unit areas (e.g. pixels) in the image belong to a target object. The greater the heat value, the higher the probability that the unit area belongs to the target object. Therefore, a target region reflecting the position of the target object can be determined based on the heat map, for example by selecting the unit areas where the possibilities are larger than a threshold to constitute the target region.

The heat map may be determined according to any known method in the art.

In some embodiments, the heat map can be the well-known class activation map (CAM). For example, the CAM can be obtained by calculating the weighted sum of the feature maps of each convolution layer of the neural network which comprises a plurality of convolution layers. Among them, the weights of each feature map represent the importance of the corresponding convolution layer to the classification of the target object, which can be determined as empiric values, or it can be obtained by training the neural network.

For example, in the case that the heat map is a CAM, the heat map of an image can be generated in the following steps:
inputting the image into a neural network;
collecting each output map of each of a plurality of convolution layers of the neural network; and
combining all of the output maps of the plurality of convolution layers into one map as the heat map of the input image.

The neural network as described above can be a trained neural network, which is capable of recognizing a target class.

For example, the neural network can have a ResNet network structure with 18 layers, and it can use, for example, each layer from the ResNet 18_Layer1 to ResNet 18_ Layer18 to extract the features of the first image.

Then, the feature maps extracted from all layers can be combined to obtain the final heat map. For example, the feature maps extracted from all layers can be weighted summed to obtain the final heat map, and the weights corresponding to each convolution layer can be obtained through training, or they can be empirical values.

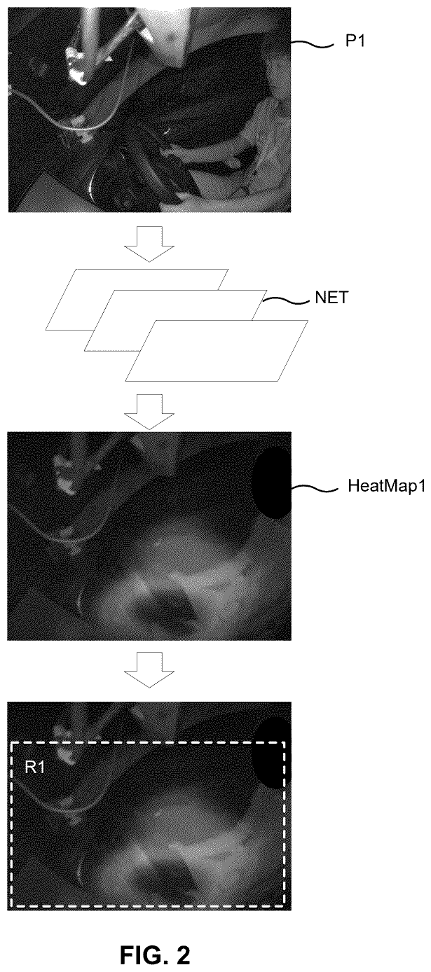

FIG. 2 shows an example process of determining a first region of a scene based on the heat map according to one of a number of embodiments of the present disclosure. For simplicity, the HoSW detection scenario is described as an example to illustrate how to calculate the heat map and further how to calculate the first region based on the heat map.

As shown in FIG. 2, the first image P1 is an image taken for the scene of a driver driving inside a vehicle. The first image P1 shows the scene where the driver holds the steering wheel with his/her hands.

The heat map HeatMap1 corresponding to the first image P1 can be generated based on the first image P1 by using a neural network NET, as shown in FIG. 2.

The heat map HeatMap1 can be a CAM corresponding to the first image P1, for example. In this case, the neural network NET can be a neural network comprising a plurality of convolution layers as described above, and the heat map HeatMap1 can be obtained by calculating the weighted sum of the feature maps of each convolution layer of the neural network.

In some embodiments, the neural network NET can have a ResNet network structure with 18 layers, as described above.

After the heat map HeatMap1 is generated based on the first image P1 by using the neural network NET, a first region R1 as shown can be determined based on the heat value distribution of the heat map HeatMap1.

Since the heat map HeatMap1 provides a heat value distribution representing the possibilities that respective unit areas (e.g. pixels) in the first image P1 belong to a target object (e.g. the steering wheel), and the higher the heat value, the higher the probability that the unit area belongs to the target object, a first region R1 of the first image P1 that covers the target object “steering wheel” can be determined based on the heat value distribution of the HeatMap1.

In some embodiments, for example, a region in the heat map HeatMap1 where the average heat value is the largest can be selected as the first region R1. For example, a fixed size sliding window can be used to traverse the entire heat map HeatMap1, and the area corresponding to the window with the largest average heat value can be determined as the first region R1 covering the target object, e.g. the steering wheel as described above. The size of sliding window can be predefined, for example, as ½, ¾ of the first image P1, or the like. In this case, the average heat value can be calculated as the sum of the heat values of all unit areas in the window divided by the number of unit areas.

In some other embodiments, an outer box of a region whose heat values are greater than a certain threshold can be determined as the first region R1. For example, if the heat values are in the range from 0 to 1, and if the greater the heat value, the higher the probability that the unit area belongs to the target object, an outer box of a region whose heat values are greater than a threshold value of 0.8 can be determined as the first region. Alternatively, other threshold values are also possible, such as 0.7, 0.6, 0.5, or the like.

It should be noted that the first region R1 indicated in the heat map HeatMap1 corresponding to the first image P1 in FIG. 2 is only illustrative, and the first region R1 of other dimensions is also possible, depending on the method and parameters used to determine the first region, as described above.

The first region determined in step 102 is a relative larger region compared with a desired ROI. Although it covers the target object, it is unfavorable to directly determine it as the desired ROI, because the size of the first region determined in step 102 is too large too accurately reflect the specific position of the target object, which will waste resources for subsequent calculations, such as classification, and may also lead to lower classification accuracy.

In order to obtain the desired ROI, the first region determined in step 102 can be shrunk based on the subsequent images of the scene. However, it may not be reliable to shrink the first region based on each single subsequent image of the scene. It is favorable to rely on a number of images to decide whether the first region should be shrunk or not, which is helpful to increasing the robustness of the determined ROI.

For example, in the HoSW detection scenario, the position of the driver's hands and the location of the steering wheel in the images may change sometimes due to vibration, resulting in that a blurred image or out of focus image may be acquired. This kind of image can be referred to as a “noisy image” or an “unexpected image”, because such kind of image cannot correctly reflect the real focus region of the neural network. If a single “noisy image” or a single “unexpected image” of the scene is used to determine whether the first region should be shrunk, it may result in wrong ROI calculation, because the corresponding heat map of the “noisy image” or “unexpected image” is a false heat map or defective heat map.

In order to exclude the above mentioned “noisy image” or “unexpected image”, it's proposed that hysteresis be used to decide whether the first region should be shrunk or not.

For example, only if the heat maps of several subsequent images continuously shows that the focus region of the neural network model is inside the first region and the difference between the first region and the focus region is greater than a threshold, the shrinking process can be triggered. This may be referred to as a “hysteresis shrinking” process, which would be able to exclude some “noisy images” or an “unexpected images” as described above, and make the shrinking algorithm more robust.

In some embodiments, the proposed “hysteresis shrinking” process may be implemented by steps 104 to 122 as shown in FIG. 1.

Referring to FIG. 1, after the first region is determined based on the first image of the scene in step 102, the method 100 may further comprise acquiring a second image of the scene (step 104) and calculating a heat map of the second image and determining a target region in the heat map (step 106); and comparing the first region with the target region to decide whether the first region contains the target region and whether the difference between the target region and the first region is greater than a first threshold Th1 (step 108).

In step 104, the “second image” can be another image of the scene captured at a different time or an image frame extracted from a video taken by a video capture device.

In step 106, the “target region” can represent a focus region of a neural network model for a function, and can be determined based on a calculated heat map of the second image. The determination of the “target region” based on the heat map of the second image may use similar ways to the determination of the “first region” based on the heat map of the first image as described above, but the target region should fit the target object more precisely.

For example, calculating a heat map of the second image and determining a target region in the heat map (step 106) may comprise two sub-steps of: (1) extracting a heat value distribution of the second image by using a neural network; and (2) determining the target region based on the heat value distribution of the second image.

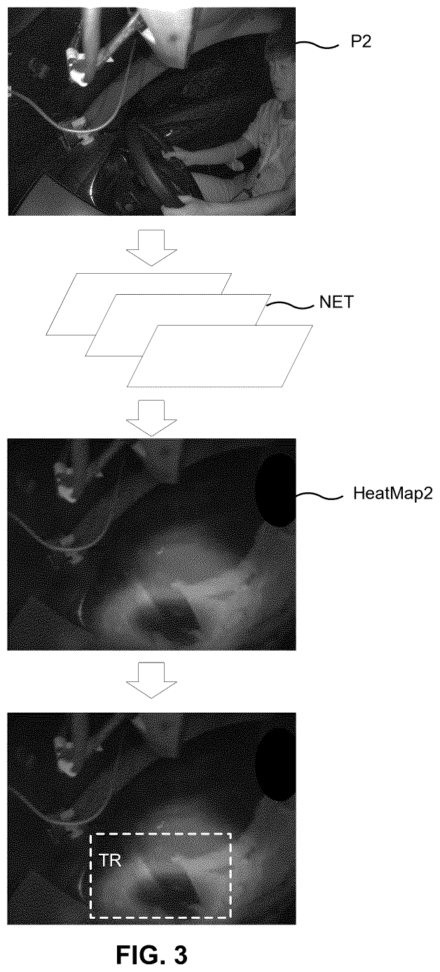

FIG. 3 shows an example process of determining a target region of a scene based on the heat map according to one of a number of embodiments of the present disclosure.

Similar to the first image P1 as shown in FIG. 2, the second image P2 is another image taken for the scene of a driver driving inside a vehicle at a subsequent timing. The second image P2 also shows the scene where the driver holds the steering wheel with his/her hands.

The heat map HeatMap2 corresponding to the second image P2 can be generated based on the second image P2 by using the same neural network NET, as shown in FIG. 3.

Further, the heat map HeatMap2 may also be a CAM corresponding to the second image P2, for example. In this case, the neural network NET can be the neural network comprising a plurality of convolution layers as described above, and the heat map HeatMap2 can be obtained by calculating the weighted sum of the feature map of each convolution layer of the neural network when the second image P2 is as an input.

The detailed generation method of the HeatMap2 can be similar as the generation of HeatMap1 described with regard to FIG. 2.

For example, in the case that the heat map HeatMap2 of the second image P2 is an CAM extracted by a neural network, generating the heat map HeatMap2 of the second image P2 may comprise steps of:
(1) inputting the second image into the neural network;
(2) collecting each output map of each of a plurality of convolution layers of the neural network; and
(3) combining all of the output maps of the plurality of convolution layers into one map as the heat map of the second image.

The neural network as described above can be the same trained neural network as used for the heat map HeatMap1.

After the heat map HeatMap2 is generated based on the second image P2 by using the neural network NET, a target region TR as shown in FIG. 3 can be determined based on the heat value distribution of the heat map HeatMap2.

Since the heat map HeatMap2 provides a heat value distribution representing the possibilities that respective unit areas (e.g. pixels) in the second image P2 belong to a target object steering wheel, and the higher the heat value, the higher the probability that the unit area belongs to the target object, the target region TR of the second image P2 that covers the target object “steering wheel” can be determined based on the heat value distribution of the HeatMap2.

In some embodiments, a region in the heat map where the heat value is greater than a certain threshold may be determined as the target region of the second image. The parameter can be obtained through training, or can be an empirical value.

In some other embodiments, an outer box (for example, a minimum outer rectangle) of a region whose heat values are greater than a certain threshold can be determined as the target region TR. For example, if the heat values are in the range from 0 to 1, and if the greater the heat value, the higher the probability that the unit area belongs to the target object, an minimum outer rectangle of a region whose heat values are greater than a threshold value of 0.9 can be determined as the target region. Alternatively, other threshold values are also possible, such as 0.95, 0.98, 0.99, or the like.

As discussed above, the first region may also be determined using the above outer box method. It should be noted that if both the first region of the first image and the target region of the second image are determined using the outer box method described above, the thresholds used in the outer box method for the first region and the target region cannot be identical, so as to make the first region larger than the target region.

For example, if an outer box of a region whose heat values are greater than a threshold value of h1 may be determined as the first region and an outer box of a region whose heat values are greater than a threshold value of h2 may be determined as the target region, h2 should be greater than h1. For example, h1 may be in the range of 0 to 0.8 and h2 may be in the range of 0.9 to 1.

In some other embodiments, a region in the heat map HeatMap2 where the average heat value is the largest may be selected as the target region TR. For example, a fixed size sliding window can be used to traverse the heat map HeatMap2, and the area corresponding to the window with the largest average heat value can be determined as the target region TR covering the target object, e.g. the steering wheel as described above. In this case, the average heat value can be calculated as the sum of the heat values of all unit areas in the window divided by the number of unit areas.

As discussed above, the first region may also be determined using the above sliding window method. It should be noted that if both the first region of the first image and the target region of the second image are determined using the sliding window method as described above, the sizes of the sliding windows for the first region and the target region cannot be identical, so as to make the first region larger than the target region.

For example, if the size of the sliding window in the first region determination is w1 and the size of the sliding window in the target region determination is w2, w2 should be smaller than w1. For example, the area of w2 can be ½, ¼, ⅛ of the area of w1, or the like.

In some other embodiments, if different methods are used to determine the first region and the target region, respectively, the parameters in their respective determination methods should be set to ensure the target region is smaller than the first region.

It should be noted that the target region TR indicated in the heat map HeatMap2 corresponding to the second image P2 in FIG. 3 is only illustrative, and target region TR of other dimensions is also possible, depending on the method and parameters used to determine the target region, as described above.

After the target region is determined in step 106 by using any one of the above methods, the first region as determined in step 102 can be compared with this target region to decide whether the first region should be shrunk.

If the first region contains the target region (that is, the target region is inside the first region) and the difference between the target region and the first region is greater than a first threshold Th1 (“Yes” in step 108), the method 100 will proceed to step 110 to check whether a counter Counter_1 equals to an integer M. M can be larger than 1.

The counter Counter_1 can be used to count the times that step 108 is performed whose resulting decision indicates “Yes”, and its initial value can be 0. The counter Counter_1 can be reset to its initial value when it reaches M−1 or when the determination of step 108 is “No” or when the method 100 restarts.

M can represent the maximum times that step 108 is performed before shrinking the first region, and can be any integer larger than 1. M may be predefined, or may be dynamically adjusted according to different application scenarios.

Referring the step 110, if the decision is “Yes” (Counter_1=M−1), a shrinking process will be triggered to shrink the first region toward the target region. Otherwise (Counter_1 is not equal to M−1), the Counter_1 will be increased by one (step 112) and steps 104 to 110 can be repeated. Please note that a different second image can be acquired from the previous image when repeating step 104.

The count Counter_1 and the integer M herein can be configured to achieve the hysteresis shrinking process, which means only if the target regions of M consecutive second images being all inside the first region and differences between the target regions of the M consecutive second images and the first region being all greater than a first threshold Th1, the first region can be shrunk. Otherwise, the first region should not be shrunk, because there might be some random noises or unexpected mistakes in the captured image as mentioned previously, which may result in a “noisy image” or an “unexpected image” that cannot correctly reflect the real focus of the scene. If such a single “noisy image” or a single “unexpected image” of the scene is used to determine whether the first region should be shrunk, it may result in wrong ROI calculation.

The difference between a target region of the second image and the first region can be represented by the amount of offset and size difference between the target region and the first region. For example, if one of the regions is offset from the other too much, the difference can be determined as large. In another example, if the sizes of the regions are very different, the difference can also be determined as large. On the other hand, if the two regions are not offset from each other much and their sizes are similar, the difference can be determined as small. A threshold can be provided to determine whether the difference is large. The threshold may be predetermined based on the manner of calculating the difference and a desired accuracy of the ROI.

In some embodiments, if the target region is inside the first region or the first region is inside the target region, the difference between the target region the first region can be represented by the area difference between the target region and the first region. For example, the area difference can be equal to the area of the first region minus the area of the target region.

Alternatively, the area difference between the target region and the first region can be represented by the following equation (1):

$$diff ( first region , target region ) = 1 - \frac{area ( target region )}{area ( first region )} \qquad ( 1 )$$

Wherein area(target region) denotes the area of the target region and area(first region) denotes the area of the first region. The greater the diff(first region, target region), the greater the difference between the first region and the target region. In this example, if diff (first region, target region) exceeds the first threshold Th1, the first region may need to be shrunk. The first threshold Th1 may be set to a predetermined value, such as 0.1, 0.05 or the like, based on a desired accuracy of the ROI value.

Alternatively, the difference between a target region of the second image and the first region may be expressed as a size and position difference between each side length of the target region and the first region in the case that the target region and the first region are in the same form of a polygon such as a rectangular.

Alternatively, the difference between a target region and the first region may be expressed by the differences between the positions of the selected points in the border of the target region and the positions of the corresponding points in the border of the first region. For example, if the target region and the first regions are both rectangles, the corners of the rectangles may be selected as the points to calculate the difference.

For example, in the case that the target region and the first region are both rectangular, a first distance between the top-left corner of the target region and the top-left corner of the first region and a second distance between the bottom-right corner of the target region and the bottom-right corner of the first region can be calculated based on their coordinates. If any one of the calculated first and second distance is larger than a certain threshold, the target region may be far away from the first region or the target region may be too small compared with the first region, and thus the difference can be determined as large.

Optionally, in the case that the target region and the first region are both polygons, the difference between the two regions can be determined by calculating the mean value or root mean square (RMS) value of the coordinate differences between the vertices of the two polygons representing the first region and the target region. If the calculated mean value or the RMS value is larger than a certain threshold, the difference can be determined as large.

If the first region contains the target region and the difference as determined by any of the above method is greater than a first threshold Th1 (“Yes” in step 108) and the Counter_1 does not equal to M−1 (“No” in step 110), the Counter_1 will be increased by one in step 112 and the method 100 will proceed to repeat steps 104 to 110 periodically, favorably at a first frequency F1.

The first frequency F1 can be set according to the required accuracy of the ROI and/or the limitation of the computing resource. For example, the first frequency F1 may be set to synchronize with the frame rate of the image capturing device which is used to capture the image of the scene. For example, if the frame rate of the image capturing device is 24 frames per second (fps), then the first frequency F1 can also be set to 24 times per second. Alternatively, the first frequency F1 may be set to be lower than the frame rate, such as 4, 8, 10 times per second.

Referring to step 108, on the contrary, if the target region is not inside the first region and/or if the difference between the target region and the first region is not greater than the first threshold Th1, the method 100 may proceed to step 114 to further check whether the difference between target region of the second image and the first region being equal to or smaller than the first threshold Th1. The difference between target region of the second image and the first region can be calculated based on any of the above-mentioned method.

If it is determined that the difference between target region of the second image and the first region being equal to or smaller than the first threshold Th1 (“Yes” in step 114), another counter, i.e. Counter_2 will be checked in step 116. Otherwise (“No” in step 114), the flow will proceed to step 104 to acquire a new second image.

Counter_2 is configured to determine whether the target regions of N consecutive second images and the first region being all equal to or smaller than the first threshold Th1. If Counter_2 equals to N−1 (“Yes” in step 116), the method 100 will proceed to step 122 to determine the current first region as the final ROI. Otherwise, Counter_2 will be increased by 1 in step 118 and the flow proceeds to step 104 to acquire a new second image.

For example, the counter Counter_2 can be used to count the times that the decision of step 114 is “Yes”, and its initial value can be 0. The counter Counter_2 can be reset to its initial value when it reaches N−1 or when the determination of step 114 is “No” or when the method 100 restarts.

It should be noted that the Counter_2 and the integer N herein are configured in order to achieve the similar effect as the forgoing “hysteresis”, which means only when the differences between the target regions of N consecutive second images and the first region are all equal to or smaller than the first threshold Th1, the current first region can be determined as the final ROI. Otherwise, if only less than N consecutive second images are proved to satisfy the condition as listed in step 114, the current first region is not a qualified ROI and further shrinking is required. This “hysteresis” as defined by the Counter_2 and the integer N also help to determine a more reliable ROI.

The integer N can be any integer that is equal to or greater than 1, such as 2, 3, 4, etc. N may be predefined, or may be dynamically adjusted according to different application scenarios.

The ROI determining method according to the above embodiments can reduce random noises or unexpected errors as described above, and thus result in a more reliable ROI and a more robust ROI determination algorithm.

In some embodiments, the shrinking process as described in steps 104-112 and 120 may be performed several times and a predetermined shrinking step can be applied in step 120 each time. In other words, the final ROI is not obtained by shrinking the first region towards the target region in one step, but step by step. For example, step 120 may comprise shrinking the first region by using a damping method with a shrinking step. Such shrinking may also be referred to as a “damping shrinking” method. In embodiments of the present disclose, the shrinking step in each round of shrinking may be determined according to the application scenarios and/or the difference between the target region and the first region to be shrunk. For example, the shrinking step may be a fixed or variable size for different rounds of shrinking, or may be a fixed or variable percentage of the difference between the target region and the first region in different rounds of shrinking. The size or percentage may be determined according to the requirements of the shrinking speed and/or the shrinking stability of the application scenarios. The shrinking step or the rules for determining the shrinking step may be predefined by a user or developer into for example the codes.

The “damping shrinking” method can not only use a shrinking step to shrink the first region step by step, but also can control the shrinking by considering the history of the target regions. The reason of using the damping method is to control vibrations and noises. For example, in the HoSW detection scenario, if a heat map of an image concentrates on the rear view mirror, that is, the target region is around the rear view mirror, the heat map or the target region may be considered as a noise. On the other hand, if a heat map of an image concentrates around the steering wheel but the target region is slightly different from the target regions of previous images, the heat map or the target region may be considered as a vibration. A damping algorithm may be used to determine the target region to shrink the first region, which considers the history of the target regions. For example, in the damping algorithms, the noise target regions may be precluded, but the vibration target regions may be combined with the target regions of the previous images to generate a resulting target region as the target to shrink the first region into the final ROI. For example, the historical target regions can be weighted averaged to generate a resulting target region. Various known damping algorithms can be applied here, for example, hysteretic damping, structural damping, viscous damping, aerodynamic damping, etc.

As mentioned previously, the shrinking process as described in steps 104-120 may be performed several times, i.e., step by step. In some embodiments, the resulting target region for shrinking the first region in one shrinking round (i.e., one round of steps 104-112 and 120) may be determined considering the target regions of the images acquired in the current step as well as the target regions in previous shrinking rounds, that is, a damping method may be applied to the target regions in multiple shrinking rounds. In some other embodiments, the damping method may be applied to the target regions of the M consecutive second images in one shrinking round to generate the resulting target region in this round. With the damping method, the target regions for determining the ROI may be more stable, resulting in a stable final ROI.

In some embodiments, the damping shrinking method can be a method to gradually shrink the first region to approximate the target region, which assembles the damping vibration in physics, wherein due to the vibration system being subject to friction, medium resistance or other energy consumption, the vibration amplitude is gradually varied with time. For example, the shrinking step size as disclosed in present method may simulate the change trend of vibration amplitude as in a vibration system, that is, the shrinking step size may be varied with time based on the historical trend of the shrinking.

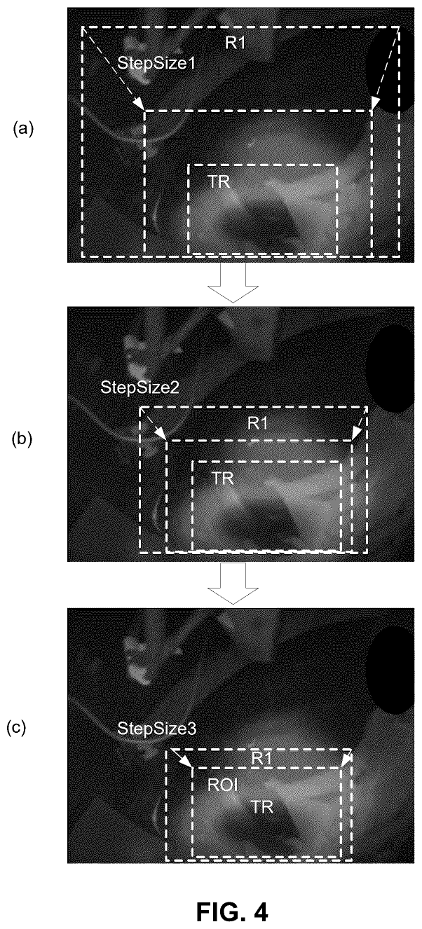

FIG. 4 shows an example damping shrinking process to obtain the final ROI according to one of a number of embodiments of the present disclosure.

As shown in FIG. 4, the initial first region is denoted by the dotted box R1 in (a) and the determined target region is denoted by the dotted box TR in (a) and (b).

The initial first region R1 can be determined as described with regard to FIG. 2, and the target region TR can be determined as described with regard to FIG. 3. Then, the first region R1 can be shrunk step by step as shown in (a)-(c).

FIG. 4 shows that the first region R1 is shrunk three times to obtain the final ROI in (c). However, this is only an example for the convenience of description. More or less steps may be taken to shrink the first region to obtain the final ROI.

With a damping shrinking process, a first shrink step size StepSize1 as shown in FIG. 4 (a) can be determined. As shown in (a), since this is the first time to shrink the first region R1, the StepSize1 may be set to a relative large value, for example, for example, equal to half of the difference between the first region R1 and the target region TR. For example, StepSize1 can be represented as the length of the arrows, or represented by the reduction of the area of the first region before and after the shrinking, and the shrinking directions are indicated by the arrows in (a).

Next, in (b), a new first region R1 can be set as the starting point of the shrinking process, wherein the new first region R1 is the resulting first region after the shrinking process as indicated in (a). In order to continue shrinking the new first region R1 toward the target region TR, a new step size StepSize2 may be determined. For example, the step size StepSize2 may be equal to half of the difference between the new first region R1 and the target region TR. A smaller StepSize2 compared with StepSize1 may be determined considering the current R1 in (b) is smaller than the past R1 in (a). The first region R1 can then be shrunk to a smaller region as pointed by the arrows in (b).

Next, in (c), a new first region R1 can be set as the starting point of the shrinking process, wherein the new first region R1 is the resulting first region after the shrinking process as indicated in (b). Similarly, in order to continue shrinking the new first region R1 toward the target region, a new step size StepSize3 may be determined. For example, the step size StepSize3 may be equal to the difference between the new first region R1 and the target region TR since the new first region R1 is very close to the target region TR (The target region TR in (c) is shown overlapped with ROI).

Assuming that after the shrinking process in (c), the differences between the target regions of N consecutive second images and the current first region are all equal to or smaller than the first threshold Th1 as described with regard to FIG. 1, the first region after the shrinking process in (c) can be determined as the final ROI.

The damping shrinking process as illustrated in FIG. 4 may be executed by multiple loops of the steps 104 to 112 and 120. That is, each time it is determined that the Counter_1 is equal to M−1 in step 110, one shrinking round can be performed. For the first time it is determined that the Counter_1 is equal to M−1 in step 110, the shrinking process (a) as shown in FIG. 4 may be executed in step 120. Then, steps 104 to 112 and 120 may be performed again to perform the shrinking processes (b) and (c) as shown in FIG. 4 in order until the final ROI is achieved. It should be noted that the target region TR for shrinking the first region R1 as shown in each of (a)-(c) may be determined by a damping method as described in the above, that is, each target region TR may be determined considering the historical target regions.

For example, the target region TR in (a) may be determined by combining the M target regions determined in the M consecutive second images acquired in this round of shrinking. The target region TR in (b) may be determined by combining the M target regions determined in the M consecutive second images acquired in this round of shrinking, or by combining the resulting target region in the previous round (i.e, the target region TR in (a)) with the M target regions determined in the M consecutive second images acquired in this round. The target region for (c) may be determined similarly.

By using the above-described “damping shrinking” method herein, the shrinking can be controlled by considering the history of the target regions, resulting in more stable target regions for determining the ROI and thus resulting in a more stable final ROI. For example, the noises and vibrations can be controlled by the damping method.

It should be noted that although the target region TR towards which the first region is shrunk may be determined by considering historical target regions in the above embodiments, other embodiments are also possible. For example, any one of the M target regions of the M consecutive second images in one shrinking round may be selected as the target region TR towards which the first region is shrunk, for example, the first or the last one of the M target regions can be selected.

In addition to the above embodiments, the present disclosure also provides embodiments for a ROI updating method, which can help to update the ROI when the scene changes.

Considering the HoSW detection scenario as described above, even in the same vehicle, the scene may change and there is a need to update the ROI. For example, assuming the image capturing device is attached to the rear view mirror, when the rear view mirror is adjusted or when another driver gets into the vehicle and adjusts the seat and seat-back, the previously determined ROI may not be suitable to the changed scene anymore. For example, the real ROI may be located far away from the previous ROI due to the orientation of the image capturing device has changed, or the real ROI may be much smaller than the previous ROI due to the focal length of the image capturing device has changed.

If the scene changes, the ROI determined based on the previous scene may no longer be suitable, which may make the accuracy of subsequent classification results drop. Therefore, it's favorable to monitor the change of the scene and update the ROI if the scene changes.

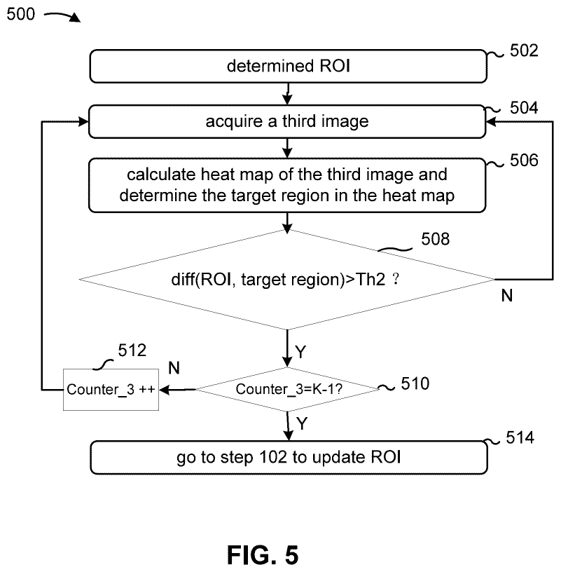

FIG. 5 illustrates an example flowchart of a method 500 for monitoring and updating the ROI of a scene according to one of a number of embodiments of the present disclosure.

As shown in FIG. 5, assuming that the ROI in the box 502 is the final ROI determined based on the method 100 as described with regard to the method 1 in FIG. 1.

In step 504, a third image can be acquired. The “third image” can be another image of the scene captured at a different time or an image frame extracted from a video taken by a video capture device.

In step 506, a heat map of the third image can be calculated and a target region in the heat map can be determined. The “target region” which can represent a focus region of a neural network model for a function can be determined based on the third image. The determination of the “target region” can be based on the heat map of the third image, which is similar to the determination of the “target region” as described above with respect to FIG. 3.

In step 508, the difference between the ROI and the target region can be calculated and whether the difference is greater than Th2 can be determined.

It should be noted that the difference between the ROI and the target region can be calculated by using any of the method as described above with respect to FIG. 1 regarding the difference between the first region and the target region, which will not be reproduced here.

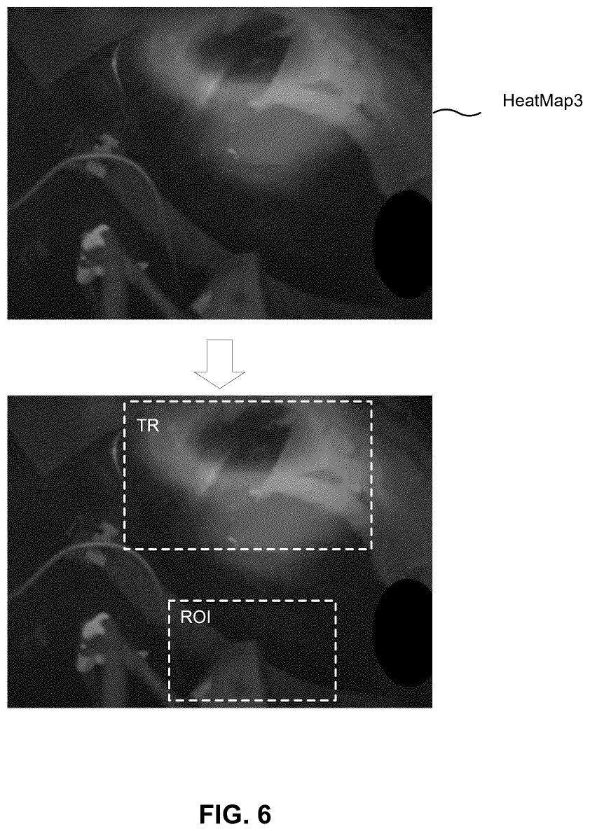

FIG. 6 shows an example of method for deciding the difference between the ROI and the target region and deciding whether to update the ROI of a scene according to one of a number of embodiments of the present disclosure.

Assuming the heat map HeatMap3 as shown in FIG. 6 is a corresponding heat map of the third image acquired in step 504. It is further assumed that the FOV of the third image has changed compared with the previous second images, which causes the location of the steering wheel change in the HeatMap3.

As shown in FIG. 6, the calculated target region TR of the third image is now in the upper half of the HeatMap3, the target region TR and the current ROI do not intersect each other at all, which means that the steering wheel is no longer within the determined ROI, but far away from the ROI.

The above difference between the target region TR and the ROI means that the scene has already changed and an update of the ROI is needed.

However, in order to determine whether the scene has already changed or the single third image is just a “noise image” or “unexpected image” as described above, K consecutive third images, instead of one third image, can be checked to decide whether differences between the target regions of the K consecutive third images and the ROI being all greater than a second threshold, wherein K is an integer larger than 1. In some embodiments, the integer K may be set to a fixed number, such as 2, 3, 4, 5 or the like. In other embodiments, the integer K may be dynamically adjusted according to different application scenarios.

For example, referring back to FIG. 5, if the difference between the target region and the ROI is greater than a second threshold Th2 (“Yes” in step 508), the method 500 will proceed to step 510 to check whether a counter Counter_3 equals to K−1.

The counter Counter_3 can be used to count the times that step 508 is performed whose result indicating “Yes”, and its initial value can be 0. The counter Counter_1 can be reset to its initial value when it reaches K−1 or when the determination of step 508 is “No” or when the method 500 restarts.

For example, in step 510, if the decision is “Yes” (Counter_3=K−1), it is decided that the scene has changed and the ROI should be updated. Then the method 500 will proceed to step 102 of the method 100 to determine a new ROI (step 514). Then, steps 102 to 122 as shown FIG. 1 will be executed and the current ROI will be replaced by a newly determined ROI.

Otherwise (Counter_3 is not equal to K−1), Counter_3 will be increased by one (Step 512) and steps 504 to 510 will be repeated.

It should be noted that the Counter_3 and the integer K herein are configured in order to achieve the similar effect as forgoing “hysteresis”, which means only when differences between the target regions of the K consecutive third images and the ROI being all greater than a second threshold Th2, the ROI will be updated. Otherwise, the ROI may not be updated, because there might be some random noises or unexpected mistakes in the captured images or the heat maps. For example, if the ROI is updated for each captured third image, it is likely that the ROI may be updated due to some “noise images”, which is not desirable.

It should be noted that if the same method is used to calculate the difference between the ROI and target region and the difference between the first region and target region as described above, it is preferable that the first threshold Th1 as described in FIG. 1 is lower than the second threshold Th2 in order to avoid unstable execution of the ROI determining process and ROI updating processing. In some embodiments, the first threshold Th1 may be set to a predetermined value such as 0.1, 0.05 or the like, based on a desired accuracy of the ROI value, and the second threshold Th2 may be set to a value such as 0.2, 0.3 or the like, which is greater than the first threshold Th1.

In some embodiments, steps 504 to 510 can be repeated at a second frequency F2. For example, the second frequency F2 can be set to 0.1, 0.01 or the like. F2=0.1 means that 1 third image can be captured every 10 seconds, and F2=0.01 means that 1 third image can be captured every 100 seconds. It should be noted that in order to avoid performing the ROI updating process too frequently and thus a waste of computing resources, the second frequency F2 may be preferred to be lower than the first frequency F1 as described with regard to the FIG. 1. For example, if the first frequency F1 is set to 10, the second frequency F2 can be set to 0.01. Other settings are also possible.

The above embodiments provide examples of monitoring the scene by comparing the current ROI with the target region of the heat map. Alternative, other monitoring techniques can also be applied to this disclosure. For example, a number of sensors can be used to monitor the objects in the scene, thereby monitoring whether the scene has changed.

Also taking the HoSW detection scenario as an example, a number of sensors can be installed on the rear view mirror, the seats and/or the steering wheel of the vehicle to sense whether the position or states of these objects change. Once the position or state of any one of those components changes, for example, over a certain threshold, the ROI updating process can be triggered. That is, the process will go to step 102 in FIG. 1 to determine a new ROI.

For example, the sensor(s) installed on the rear view mirror, the seat or the steering wheel of the vehicle can be at least one of a displacement sensor, a deformation sensor, a pressure sensor, and an acceleration sensor.

The above describes the ROI updating methods proposed in the present disclosure in combination with FIG. 5 and FIG. 6. By introducing a similar hysteresis defined by the Counter_3 and K, this ROI updating method is beneficial to reduce random noises or unexpected errors, thus helping to avoid mis-updating and to construct a more robust ROI determination algorithm.

Various embodiments are described above regarding how to determine the ROI in a scene and how to update the ROI.

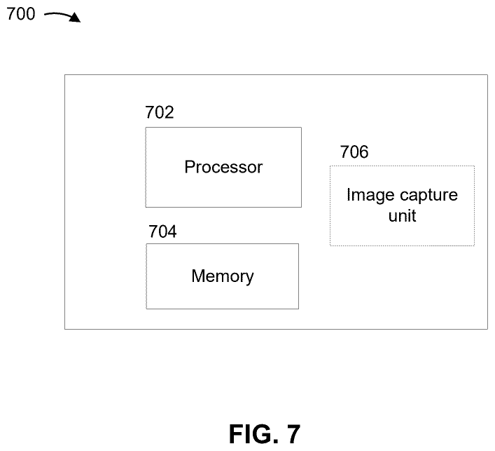

The present disclosure also provides an apparatus for determining a region of interest (ROI) of a scene. FIG. 7 is a block diagram of an example apparatus 700 for implementing the ROI determining method as described in the present disclosure.

As shown in FIG. 7, the apparatus 700 comprises a processor 702 and a non-transitory memory 704 with instructions thereon. When the instructions are executed by the processor 704, it can cause the processor 702 to implement any of method as described above with respect to FIG. 1 to FIG. 6, which will not be reproduced here. Various methods and features described above with respect to FIGS. 1 to 6 are also applicable to the apparatus 700, unless it is obviously inappropriate from the context.

In some embodiments, the apparatus 700 may also include an image capture unit 706, which is similar to the image capturing device as described above. The image capture unit 706 may be used to capture the images of a scene, and the captured images may be acquired by processor 702.

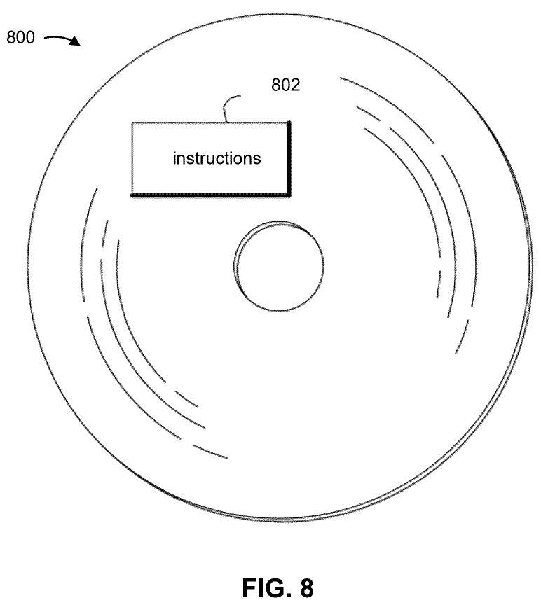

The present disclosure also provides a non-transitory computer-readable storage medium for determining a region of interest (ROI) of a scene. FIG. 8 is an illustration of an example computer-readable storage medium 800 for implementing the ROI determining method as described in the present disclosure.

As shown in FIG. 8, the computer-readable storage medium 800 has instructions 802 stored thereon and the instructions 802 can cause a processor to implement any of method as described above with respect to FIG. 1 to FIG. 6, which will not be reproduced here. Various methods and features described above with respect to FIGS. 1 to 6 are also applicable to the computer-readable storage medium 800, unless it is obviously inappropriate from the context.

The foregoing detailed description of the present disclosure has been presented for purposes of illustration and description. It is not intended to be exhaustive or to limit the technology to the precise form disclosed. Many modifications and variations are possible in light of the above teaching. The described embodiments were chosen to best explain the principles of the technology and its practical application to thereby enable others skilled in the art to best utilize the technology in various embodiments and with various modifications as are suited to the particular use contemplated. It is intended that the scope of the technology be defined by the claims appended hereto.

1. A method for determining a region of interest (ROI) of a scene, the method comprising the steps of:
a) determining a first region based on a first image of the scene;
b) acquiring a second image of the scene;
c) calculating a heat map of the second image and determining a target region in the heat map;
d) repeating steps b)-c) at a first frequency and shrinking the first region in response to target regions of M consecutive second images being all inside the first region and differences between the target regions of the M consecutive second images and the first region being all greater than a first threshold, wherein M is an integer larger than 1; and
e) determining the first region as the ROI of the scene in response to differences between the target regions of N consecutive second images and the first region being all equal to or smaller than the first threshold, wherein N is an integer equal to or larger than 1.

2. The method of claim 1, wherein shrinking the first region comprising shrinking the first region by using a damping method with a shrinking step.

3. The method of claim 1, further comprising a step of:
f) monitoring the scene and updating the ROI if the scene changes.

4. The method of claim 3, wherein monitoring the scene comprising steps of:
g) acquiring a third image of the scene;
h) calculating a heat map of the third image and determining the target region in the heat map; and
i) repeating steps g)-h) at a second frequency and determining that the scene changes in response to differences between the target regions of the K consecutive third images and the ROI being all greater than a second threshold, wherein K is an integer larger than 1.

5. The method of claim 4, wherein the second frequency is lower than the first frequency.

6. The method of claim 3, wherein monitoring the scene comprising steps of:
acquiring sensing information of at least one object in the scene; and
determining that the scene changes if the sensing information of at least one object changes.

7. The method of claim 3, wherein updating the ROI comprising:
performing steps a)-e) and replacing the ROI with a newly determined ROI.

8. The method of claim 1, wherein calculating the heat map of the second image and determining the target region in the heat map comprising steps of:
extracting a heat value distribution of the second image by using a neural network; and
determining the target region based on the heat value distribution of the second image.

9. The method of claim 8, wherein the heat map of the second image is a class activation map (CAM), and calculating the heat map of the second image comprising steps of:
inputting the second image into the neural network;
collecting each output map of each of a plurality of convolution layers of the neural network; and
combining all of the output maps of the plurality of convolution layers into one map as the heat map of the second image.

10. An apparatus for determining a region of interest (ROI) of a scene, the apparatus comprising a processor and a non-transitory memory with instructions thereon, wherein the instructions upon execution by the processor, cause the processor to execute the steps of:
a) determining a first region based on a first image of the scene;
b) acquiring a second image of the scene;
c) calculating a heat map of the second image and determining a target region in the heat map;
d) repeating steps b)-c) at a first frequency and shrinking the first region in response to target regions of M consecutive second images being all inside the first region and differences between the target regions of the M consecutive second images and the first region being all greater than a first threshold, wherein M is an integer larger than 1; and
e) determining the first region as the ROI of the scene in response to differences between the target regions of N consecutive second images and the first region being all equal to or smaller than the first threshold, wherein N is an integer equal to or larger than 1.

11. The apparatus of claim 10, wherein shrinking the first region comprising shrinking the first region by using a damping method with a shrinking step.

12. The apparatus of claim 10, wherein the instructions upon execution by the processor, further cause the processor to execute a step of:
f) monitoring the scene and updating the ROI if the scene changes.

13. The apparatus of claim 12, wherein monitoring the scene comprising steps of:
g) acquiring a third image of the scene;
h) calculating a heat map of the third image and determining the target region in the heat map; and
i) repeating steps g)-h) at a second frequency and determining that the scene changes in response to differences between the target regions of the K consecutive third images and the ROI being all greater than a second threshold.

14. The apparatus of claim 13, wherein the second frequency is lower than the first frequency.

15. The apparatus of claim 12, wherein monitoring the scene comprising steps of:
acquiring sensing information of at least one object in the scene; and
determining that the scene changes if the sensing information of at least one object changes.

16. The apparatus of claim 12, wherein updating the ROI comprising: performing steps a)-e) and replacing the ROI with a newly determined ROI.

17. The apparatus of claim 10, wherein c) calculating the heat map of the second image and determining the target region in the heat map comprising:
extracting a heat value distribution of the second image by using a neural network; and
determining the target region based on the heat value distribution of the second image.

18. The apparatus of claim 17, wherein the heat map of the second image is a class activation map (CAM), and calculating the heat map of the second image comprising steps of:
inputting the second image into the neural network;
collecting each output map of each of a plurality of convolution layers of the neural network; and
combining all of the output maps of the plurality of convolution layers into one map as the heat map of the second image.

19. A non-transitory computer-readable storage medium storing instructions that cause a processor to execute the steps of:
a) determining a first region based on a first image of a scene;
b) acquiring a second image of the scene;
c) calculating a heat map of the second image and determining a target region in the heat map;
d) repeating steps b)-c) at a first frequency and shrinking the first region in response to the target regions of M consecutive second images being all inside the first region and differences between the target regions of the M consecutive second images and the first region being all greater than a first threshold, wherein M is an integer larger than 1; and
e) determining the first region as the ROI of the scene in response to differences between the target regions of N consecutive second images and the first region being all equal to or smaller than the first threshold, wherein N is an integer equal to or larger than 1.
